(19) United States
(12) Patent Application Publication
(10) Pub. No.: US 2007/0103533 A1
(43) Pub. Date: May 10, 2007

(54) Combination of monochromatic-printing and color-printing device

(76) Inventor: Yueh-Shing Lee, Hsinchu (TW)

Correspondence Address: LIN & ASSOCIATES INTELLECTUAL PROPERTY, P.O. BOX 2339, SARATOGA, CA, 95070-0339, US

(21) Appl. No.: 11/271,675

(22) Filed: Nov. 10, 2005

(51) Int. Cl. B41J 2/01

(52) U.S. Cl. 347/104

(57) ABSTRACT

A combination of monochromatic-printing and color-printing device includes a feeding tray for supplying print media, an output tray in which the print media printed in a print job are interleaved and collated, and a paper transport path connecting the feeding tray and the output tray. The paper transport path has a plurality of driving rollers for transporting the print media from the feeding tray to the output tray, a monochromatic print unit for monochromatic printing and a color print unit for color printing disposed thereat. At least one of the monochromatic print unit and the color print unit is controlled to be in work corresponding to a print job.

### BACKGROUND OF THE INVENTION

1. Field of the Invention

The present invention relates to an image-printing device, and more particularly to a combination of monochromatic-printing and color-printing device.

2. The Related Art

Generally, printers are approximately divided into dot-matrix printers, thermal printers, inkjet printers and laser printers. The inkjet printer and the laser printer occupy the most market.

As is well known, the cost of printing a monochromatic page by the inkjet printer is higher than that by the laser printer, while the cost of printing a color page by the laser printer is far higher than that by the inkjet printer, and the color printing quality by the laser printer is worse than that by the inkjet printer. Therefore, a printing device with combination of inkjet printer and laser printer is needed to facilitate users selecting the cheapest and the most quality method for a printing job.

U.S. Pat. No. 6,582,039 issued on Jun. 24, 2003 by Johnson et al. provides a combination color inkjet and laser image-printing device. The conventional image-printing device comprises a laser print engine, an inkjet print engine and a paper-picking device. The paper-picking device comprises a first paper-picking mechanism and a second paper-picking mechanism. The first paper-picking mechanism feeds print media from the single supply of a print medium to a first transport path where the laser print engine is disposed, and the second paper-picking mechanism feeds print media from the single supply of print medium to a second transport path where the inkjet print engine is disposed.

Although the conventional image-printing device can provide both laser printing and inkjet printing functions, however it has two paper-picking mechanism and two paper transport paths. So the conventional image-printing device is too complex and too bulky to satisfy the market need of small-sized printers.

### SUMMARY OF THE INVENTION

An object of the present invention is to provide a combination of monochromatic-printing and color-printing device comprising a feeding tray for supplying print media, an output tray in which the print media printed in a print job are interleaved and collated, and a paper transport path connecting the feeding tray and the output tray. The paper transport path has a plurality of driving rollers for transporting the print media from the feeding tray to the output tray, a monochromatic print unit for monochromatic printing and a color print unit for color printing disposed thereat. At least one of the monochromatic print unit and the color print unit is controlled to be in work corresponding to a print job.

As stated, the combination of monochromatic-printing and color-printing device realizes the objective of monochromatic-printing and color-printing by disposing the monochromatic and color print units in a single paper transport path, thus the printer is simple and can be miniaturized to satisfy the market need of small-sized printers.

### BRIEF DESCRIPTION OF THE DRAWINGS

The present invention will be apparent to those skilled in the art by reading the following description of preferred embodiments thereof, with reference to the attached drawings, in which:

FIG. 1 is a schematic view of a first embodiment of a combination of monochromatic-printing and color-printing device according to the present invention;

FIG. 2 is a schematic view of a second embodiment of a combination of monochromatic-printing and color-printing device according to the present invention;

FIG. 3 is a schematic view of a third embodiment of a combination of monochromatic-printing and color-printing device according to the present invention;

FIG. 4 is a schematic view of a fourth embodiment of a combination of monochromatic-printing and color-printing device according to the present invention;

FIG. 5 is a schematic view of a fifth embodiment of a combination of monochromatic-printing and color-printing device according to the present invention;

FIG. 6 is a schematic view of a sixth embodiment of a combination of monochromatic-printing and color-printing device according to the present invention;

FIG. 7 is a schematic view of the sixth embodiment of the combination of monochromatic-printing and color-printing device in another state;

FIG. 8 is a schematic view of a seventh embodiment of a combination of monochromatic-printing and color-printing device according to the present invention;

FIG. 9 is a schematic view of the seventh embodiment of the combination of monochromatic-printing and color-printing device in another state;

FIG. 10 is a schematic view of an eighth embodiment of a combination of monochromatic-printing and color-printing device according to the present invention; and

FIG. 11 is a schematic view of the eighth embodiment of the combination of monochromatic-printing and color-printing device in another state.

### DETAILED DESCRIPTION OF THE PREFERRED EMBODIMENTS

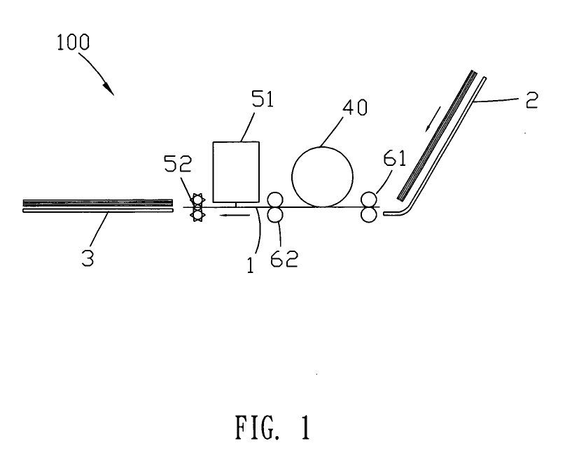

Referring to FIGS. 1 to 11, a combination of monochromatic-printing and color-printing device 100 comprises a feeding tray 2 for supplying print media, an output tray 3 in which the print media printed in a print job are interleaved and collated, and a paper transport path 1 connecting the feeding tray 2 and the output tray 3. The print media are transported forwards in the paper transport path 1 along the transport direction of the print media (the arrowed direction shown in drawings). The paper transport path 1 has a plurality of driving rollers for transporting the print media from the feeding tray 2 to the output tray 3, a monochromatic print unit for monochromatic printing and a color print unit for color printing disposed thereat. The color print unit can be disposed at back or front of the monochromatic print unit. The monochromatic print unit and the color print unit may be an inkjet print unit, a thermal print unit or others. In all embodiments of the present invention, the monochromatic print unit is a laser print unit, and the color print unit is an inkjet print unit.

Referring to FIG. 1, in a first embodiment of the present invention, the paper transport path 1 is horizontally arranged. The laser print unit comprises a photo conductor 40 lying above the paper transport path 1. The inkjet print unit lies in front of the laser print unit and comprises an inkjet printhead 51 and a ratchet 52. The ratchet 52 lies in front of the inkjet printhead 51. The inkjet printhead 51 lies above the paper transport path 1.

The driving rollers comprise a set of first driving rollers 61 and a set of second driving rollers 62. The first driving rollers 61 lying at rear end of the paper transport path 1 are adapted to transport the print media from the feeding tray 2 to the paper transport path 1. The second driving rollers 62 lying between the laser print unit and the inkjet print unit are adapted to transport the print media ahead along the paper transport path 1.

Referring to FIG. 1 again, in use, firstly, the print media are transported from the feeding tray 2 to the paper transport path 1 by the first driving rollers 61.

When printing a monochromatic page, firstly, control the laser print unit be in work and the inkjet print unit be out of work. While, a print medium passing the photo conductor 40 is printed into a monochromatic page by the laser print unit. Lastly, the monochromatic page is transported to the output tray 3 by the second driving rollers 62 and the ratchet 52.

When printing a color page, firstly, control the laser print unit be out of work and the inkjet print unit be in work. While, a print medium passing the photo conductor 40 is not printed by the laser print unit and then is transported to the second driving rollers 62. To follow, the print medium is transported to pass the inkjet printhead 51 by the second driving rollers 62. Simultaneously, the print medium passing the inkjet printhead 51 is printed into a color page and then is transported to the output tray 3 by the ratchet 52.

When printing a monochromatic and color page, firstly, control the laser print unit and the inkjet print unit be both in work. While, a print meduim passing the photo conductor 40 is printed into a monochromatic page by the laser print unit and then is transported to the second driving rollers 62. To follow, the monochromatic page is transported to pass the inkjet printhead 51 by the second driving rollers 62. Simultaneously, the monochromatic page passing the inkjet printhead 51 is printed into a monochromatic and color page and then is transported to the output tray 3 by the ratchet 52.

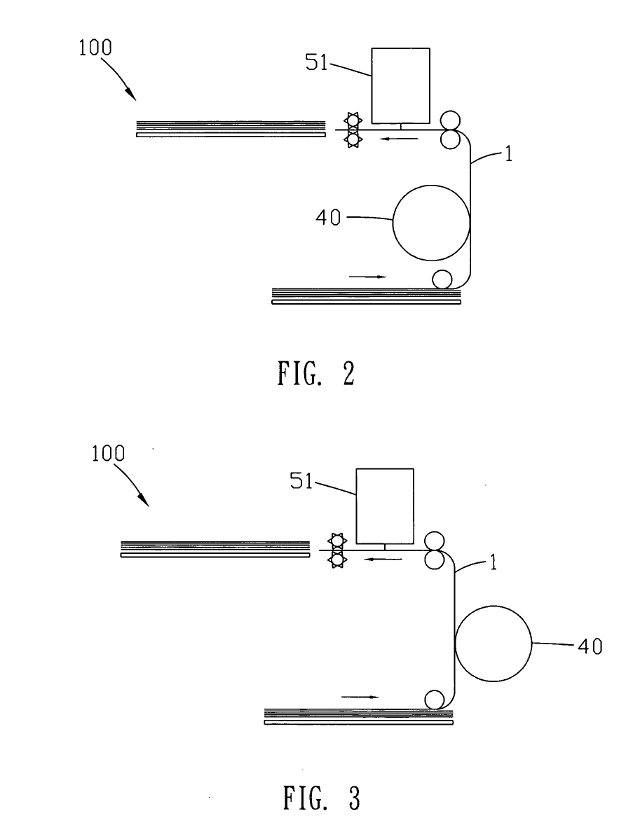

Referring to FIG. 2, in a second embodiment of the present invention, the paper transport path 1 appears U-shaped. The inkjet print unit lies in front of the laser print unit along the transport direction of the print media. The inkjet printhead 51 of the inkjet print unit lies at one side of the paper transport path 1, and the photo conductor 40 of the laser print unit lies at the other side of the paper transport path 1.

Referring to FIG. 3, in a third embodiment of the present invention, the paper transport path 1 appears U-shaped. The inkjet print unit lies in front of the laser print unit along the transport direction of the print media. The inkjet printhead 51 of the inkjet print unit and the photo conductor 40 of the laser print unit lies at the same side of the paper transport path 1.

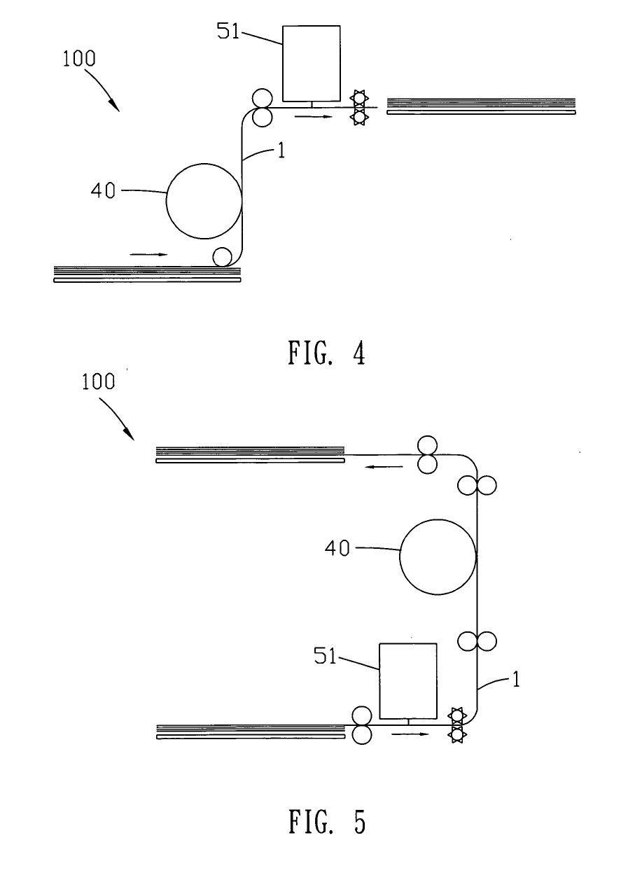

Referring to FIG. 4, in a fourth embodiment of the present invention, the paper transport path 1 appears ladder-shaped. The inkjet print unit lies in front of the laser print unit along the transport direction of the print media. The inkjet printhead 51 of the inkjet print unit lies at one side of the paper transport path 1, and the photo conductor 40 of the laser print unit lies at the other side.

Referring to FIG. 5, in a fifth embodiment of the present invention, the paper transport path 1 appears horizontal U-shaped. The inkjet print unit lies at back of the laser print unit along the transport direction of the print media. The inkjet printhead 51 of the inkjet print unit and the photo conductor 40 of the laser print unit lies at the same side of the paper transport path 1.

The other structure and the process of use in the above-mentioned second to fifth embodiment is the same to the first embodiment, thus will not be referred.

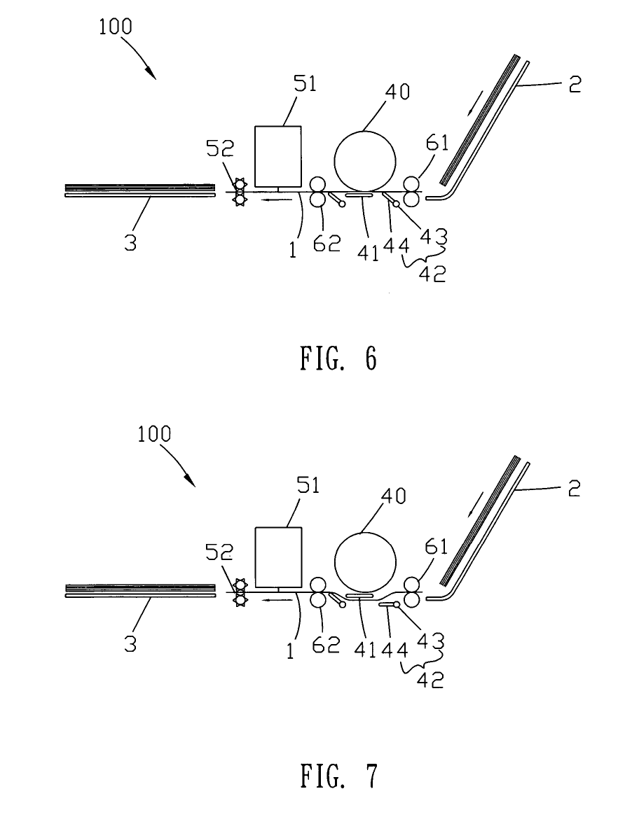

As shown in FIG. 6, in the sixth embodiment of the present invention, the paper transport path 1 is horizontally arranged. The inkjet print unit lies in front of the laser print unit along the transport direction of the print media.

The laser print unit comprises a photo conductor 40, a shelter plate 41 and a movable member 42. The photo conductor 40 and the shelter plate 41 are disposed in opposition to each other along the vertical of the transport direction of the print media. The photo conductor 40 lies above the paper transport path 1, the shelter plate 41 lies below the paper transport path 1. The movable member 42 is at the same side of the paper transport path 1 with the shelter plate 41 and lies at back of the shelter plate 41 along the transport direction of the print media. The movable member 42 further comprises an axle 43 and a movable shaft 44. The movable shaft 44 connects to the axle 43 and rotates around the axle 43.

The inkjet print unit comprises an inkjet printhead 51 and a ratchet 52. The ratchet 52 lies in front of the inkjet printhead 51, the inkjet printhead 51 lies above the paper transport path 1.

The driving rollers comprise a set of first driving rollers 61 and a set of second driving rollers 62. The first driving rollers 61 lying at back end of the paper transport path 1 are adapted to transport the print media from the feeding tray 2 to the paper transport path 1. The second driving rollers 62 lying between the laser print unit and the inkjet print unit are adapted to transport the print media ahead along the paper transport path 1.

As shown in FIG. 6 and FIG. 7, in use, firstly, the print media are transported from the feeding tray 2 to the paper transport path 1 by the first driving rollers 61.

Referring to FIG. 6, when printing a monochromatic page, firstly, control the inkjet print unit be out of work. While, the movable member 42 lies in the first movable position, the free end of the movable shaft 44 is on the same horizontal plane with the shelter plate to support a print medium be transported on the paper transport path 1. After passing the movable member 42, the print medium passes through between the photo conductor 40 and the shelter plate 41. Meanwhile, the print medium passing the photo conductor 40 is printed into a monochromatic page by the laser print unit. Lastly, the monochromatic page is transported to the output tray 3 by the second driving rollers 62 and the ratchet 52.

Referring to FIG. 6 again, when printing a monochromatic and color page, firstly, control the inkjet print unit be in work. A print medium being printed into a monochromatic page by the laser print unit is transported to the second driving rollers 62 and then is transported to pass the inkjet printhead 51 by the second driving rollers 62. Meanwhile, the monochromatic page passing the inkjet printhead 51 is printed into a monochromatic and color page and then is transported to the output tray 3 by the ratchet 52.

As shown in FIG. 7, when printing a color page, firstly, control the inkjet print unit be in work. While, the movable shaft 44 of the movable member 42 rotates around the axle 43 and is fixed at position parallel to the shelter plate 41 to enable the movable member 42 be in the second movable position. Then, the print medium deviates downwards from the paper transport path 1 and passes through under the shelter plate 41. Thus, the print medium detours the photo conductor 40 so that the laser print unit does not print the print medium. To follow, the print medium is transported to the second driving rollers 62 and passes the inkjet printhead 51 by the second driving rollers 62. While, the print medium is printed into a color page by the inkjet print unit. Then, the color page is transported to the output tray 3 by the ratchets 52.

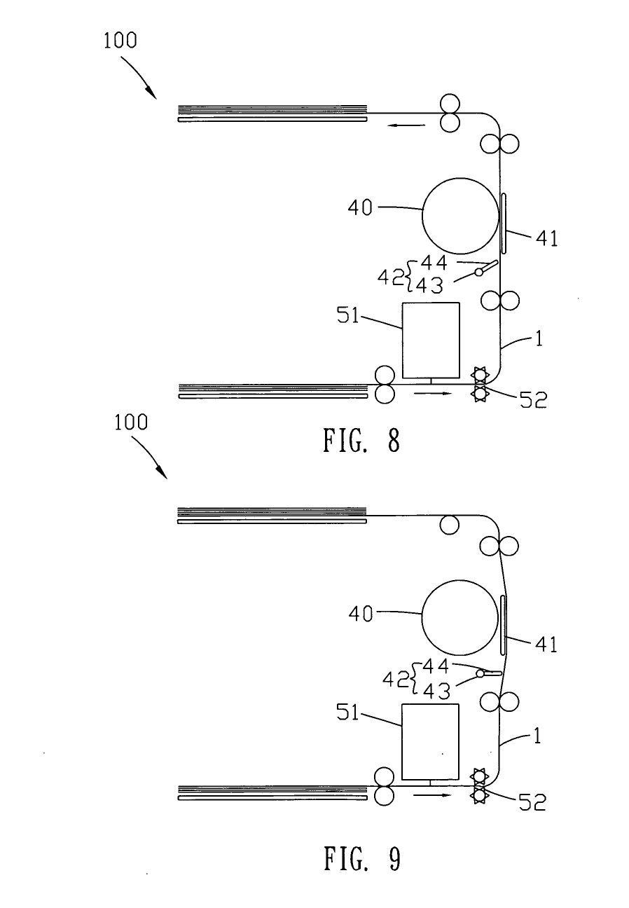

Referring to FIG. 8, in a seventh embodiment of the present invention, the paper transport path 1 appears U-shaped. The inkjet print unit lies at back of the laser print unit along the transport direction of the print media. The inkjet printhead 51 and the photo conductor 40 are at the same side of the paper transport path 1. The movable member 42 of the laser print unit lies at back of the photo conductor 40 and the shelter plate 41. The movable member 42 and the photo conductor 40 are at the same side of the paper transport path 1.

Referring to FIG. 8 and FIG. 9, in use, firstly, the print media is transported to the paper transport path 1.

As shown in FIG. 8, when printing a monochromatic page, firstly, control the inkjet print unit be out of work. While, the free end of the movable shaft 44 slopes to the paper transport path 1 to enable the movable member 42 be in the first movable position, therefore a print medium passes through between the photo conductor 40 and the shelter plate 41 for being monochromatically printed.

Referring to FIG. 8 again, when printing a monochromatic and color page, firstly, control the inkjet print unit be in work. While, a print medium passes below the inkjet printhead 51 for being color printed, then passes through between the photo conductor 40 and the shelter plate 41 for being monochromatically printed.

Referring to FIG. 9, when printing a color page, firstly, control the inkjet print unit be in work. While, a print medium passes below the inkjet printhead 51 for being color printed, then, the movable shaft 44 rotates backwards around the axle 43 and is fixed at position vertical to the transport direction of the print media. While, the free end of the movable shaft 44 moves to the side of the shelter plate 41 to enable the movable member 42 be in the second position. While, the color page passes the movable shaft 44 and is propped by the movable shaft 44 to pass from the outside of the shelter plate 41. Thus the color page detours the photo conductor 40 so that the laser print unit does not print the page.

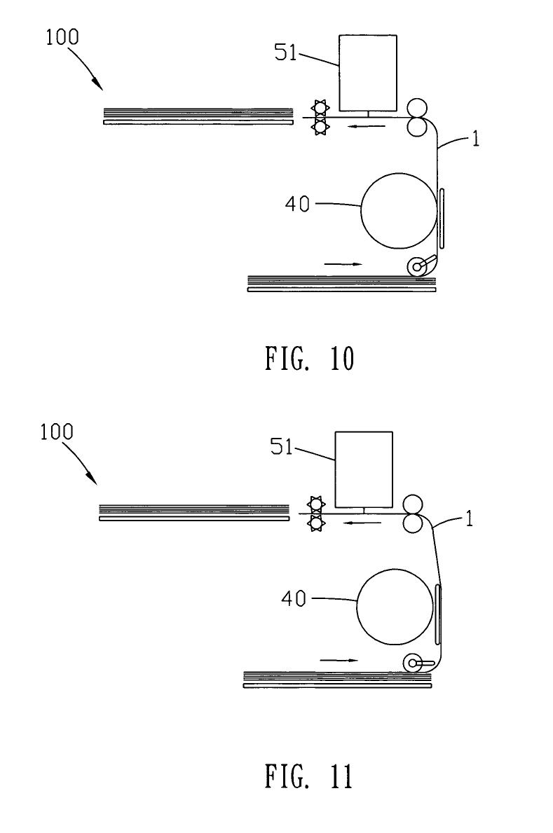

Referring to FIG. 10 and FIG. 11, the difference between an eighth embodiment and the seventh embodiment of the present invention lies in: the inkjet print unit lies in front of the laser print unit along the transport direction of the print media, the inkjet printhead 51 of the inkjet print unit lies at one side of the paper transport path 1, the photo conductor 40 of the laser print unit lies at the other side of the paper transport path 1. The use process of the present embodiment is similar to the seventh embodiment of the present invention.

As stated, the combination of monochromatic-printing and color-printing device 100 realizes the objective of monochromatic-printing and color-printing by disposing the monochromatic and color print units in a single paper transport path 1, thus the printer can be miniaturized, therefore the market need of the small-sized printer is satisfied.

What is claimed is:

1. A combination of monochromatic-printing and color-printing device comprising:
a feeding tray for supplying print media;
an output tray in which the print media printed in a print job are interleaved and collated;
a paper transport path connecting said feeding tray and said output tray;
a plurality of driving rollers disposed at said paper transport path for transporting the print media from said feeding tray to said output tray;
a monochromatic print unit disposed at said paper transport path for monochromatic printing; and
a color print unit disposed at said paper transport path for color printing;
wherein at least one of said monochromatic print unit and said color print unit is controlled to be in work corresponding to a print job.

2. The combination of monochromatic-printing and color-printing device as claimed in claim 1, wherein the color print unit lies in front of the monochromatic print unit along the transport direction of the print media.

3. The combination of monochromatic-printing and color-printing device as claimed in claim 1, wherein the color print unit lies at back of the monochromatic print unit along the transport direction of the print media.

4. The combination of monochromatic-printing and color-printing device as claimed in claim 1, wherein the color print unit is an inkjet print unit, the inkjet print unit comprises an inkjet printhead and a set of ratchets, the ratchets are in front of the inkjet printhead along the transport direction of the print media.

5. The combination of monochromatic-printing and color-printing device as claimed in claim 1, wherein the color print unit is a thermal printer.

6. The combination of monochromatic-printing and color-printing device as claimed in claim 1, wherein the monochromatic print unit is a laser print unit.

7. The combination of monochromatic-printing and color-printing device as claimed in claim 6, wherein the laser print unit comprises a photo conductor, a shelter plate and a movable member; the movable member is disposed at back of the photo conductor and the shelter plate along the transport direction of the print media movable member and is movable between a first movable position which allows the print media to pass through between the photo conductor and the shelter plate so as to be printed by the laser print unit and a second movable position which allows the print media to pass through from backside of the shelter plate so as to avoid the photo conductor.
